(19) United States
(12) Patent Application Publication
(10) Pub. No.: US 2005/0115369 A1
(43) Pub. Date: Jun. 2, 2005

(54) Constant force socket

(76) Inventors: Ming-Hua Li, Tai Chung City (TW); Li-Hsia Lin, Tai Chung City (TW); Mei-Chin Chou, Tai Ping City (TW)

Correspondence Address: RABIN & BERDO, P.C., Suite 500, 1101 14th Street, N.W., Washington, DC, 20005, US

(21) Appl. No.: 10/722,429

(22) Filed: Nov. 28, 2003

(51) Int. Cl. B25B 23/00

(52) U.S. Cl. 81/429

(57) ABSTRACT

A constant force socket is constructed to include a socket body, which has an inner hole at one end and a set of teeth radially disposed inside the inner hole, a ratchet wheel, which is mounted inside the inner hole of the socket body and has a tool hole at one side and a set of radially arranged teeth at an opposite side, a screw member threaded into the inner hole of the socket body, and a compression spring supported between the ratchet wheel and the screw member to force the teeth of the ratchet wheel into engagement with the teeth of the socket body.

### BACKGROUND OF THE INVENTION

1. Field of the Invention

The present invention relates generally to a socket for use with a wrench or the like to turn bolts and nuts, and more particularly, to a constant force socket, which enables the user to apply a constant torsional force to the workpiece.

2. Description of the Related Art

Regular torsion tools include two types, namely, the conventional mechanical types and the electronic types. These two different types of torsion tools have different prices and are for different applications. Regular sockets for use with torsion tools do not provide an applied force or torsional force control function. Ease of use is the only function of conventional sockets. When in use, a socket works as an adapter between the torsion tool (wrench or power hand tool) and the workpiece (screw bolt or not). During use, the control and maintenance of applied force are completely decided by the user. However, it is difficult to get the information of the margin of safety of every product from the assembly line. An electronic torsion tool (for example, an electronic wrench) can only measure the amount of force applied at each time. It cannot control the amount of applied force, or keep the applied force within a constant range.

A conventional socket is to be sued with a torsion tool to lock/unlock a bolt or nut. However, the locking force is determined subject to the user's feeling. Excessively high locking force may cause damage to the workpiece. Insufficient locking force cannot lock the workpiece positively.

FIG. 1 shows a conventional socket for use with a torsion tool to turn a bolt or nut. This structure of socket may be made in different sizes to fit different bolts and nuts. However, this structure of socket cannot control the applied torsional force.

### SUMMARY OF THE INVENTION

The present invention has been accomplished under the circumstances in view. It is the main object of the present invention to provide a constant force socket, which enables the user to adjust apply a constant torsional force to the workpiece. It is another object of the present invention to provide a constant force socket, which enables the user to adjust the set torsional force.

To achieve these and other objects of the present invention, the constant force socket comprises a socket body, the socket body having an inner hole axially extended to one end thereof and a set of teeth radially disposed around the border inside the inner hole; a ratchet wheel mounted in the inner hole inside the socket body, the ratchet wheel having a tool hole disposed at one side thereof and adapted to receive a torsion tool to be inserted into the inner hole of the socket body, and a set of teeth radially disposed at an opposite side thereof and adapted to engage the teeth of the socket body; a screw member threaded into the inner hole of the socket body; and spring means mounted in the inner hole inside the socket body and stopped between the screw member and the ratchet wheel to force the ratchet wheel into engagement with the teeth of the socket body. By means of rotating the screw member inwards/outwards in the inner hole of the socket body, the spring force of the spring means is adjusted, and therefore the set torsional force is relatively changed.

### BRIEF DESCRIPTION OF THE DRAWINGS

FIG. 1 is an elevational view of a socket according to the prior art.

FIG. 2 is a sectional view of a constant force socket according to the present invention.

FIG. 3 is a left side view of the constant force socket according to the present invention.

FIG. 4 is a right side view of the constant force socket according to the present invention.

FIG. 5 is an elevational view of the socket body for the constant force socket according to the present invention.

FIG. 6 is a perspective view of the ratchet wheel for the constant force socket according to the present invention.

FIG. 6A is an enlarged view of part A of FIG. 6.

FIG. 7 is a schematic drawing showing the tooth form of the ratchet wheel for the constant force socket according to the present invention.

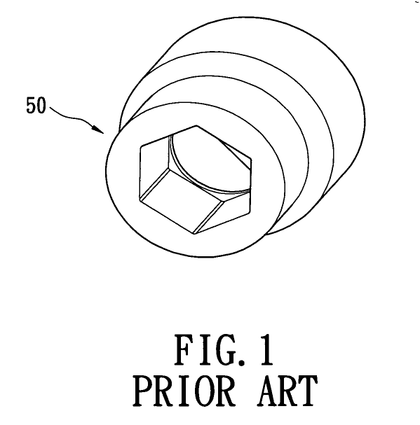

### DETAILED DESCRIPTION OF THE INVENTION

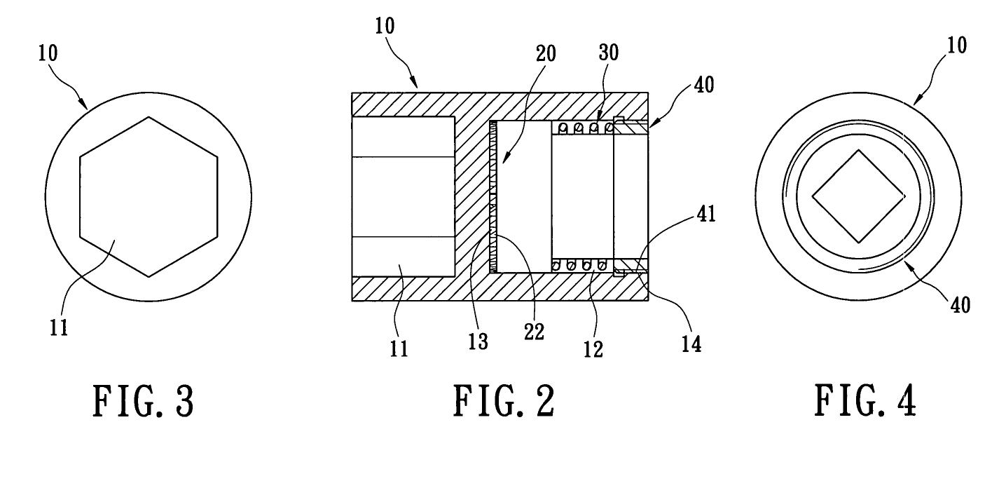

Referring to FIGS. 2˜4, a constant force socket in accordance with the present invention is shown comprised of a socket body 10, a stepped ratchet wheel 20, a spring member 30, and a screw member 40.

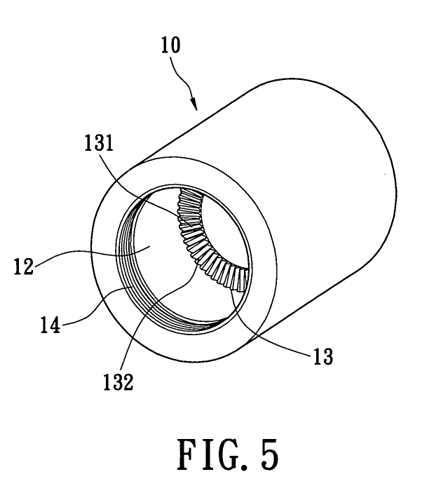

The socket body 10 is a hollow block having a coupling hole 11 axially extended to one end and adapted to receive a locating member (for example a screw nut or screw bolt), an inner hole 12 axially extended to the other end, a set of teeth 13 radially disposed at the inner side inside the inner hole 12 (see FIG. 5), and an inner thread 14 extended around the inside wall within the inner hole 12 near the outer side. The teeth 13 each have a first sidewall 131 and a second sidewall 132 respectively sloping at two sides at different angles for locking/unlocking control. Alternatively, the teeth 13 can be made having the respective first sidewall 131 to be a sloping wall and the respective second sidewall 132 to be a vertical wall.

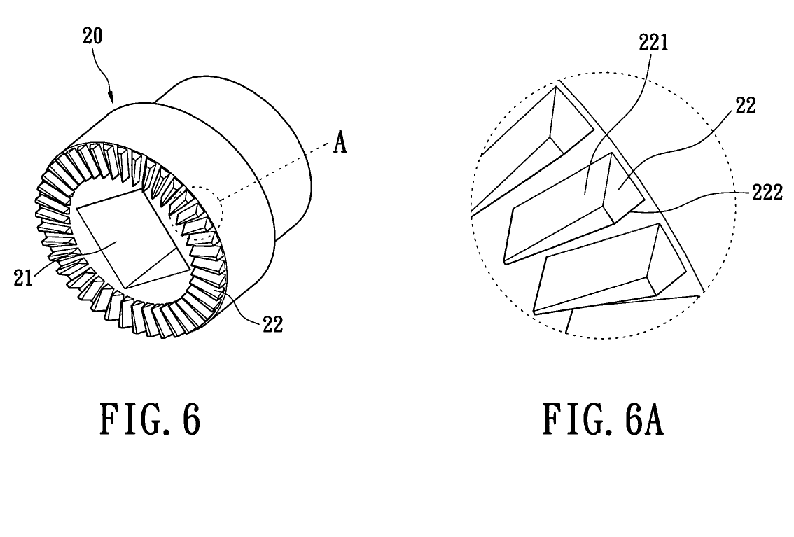

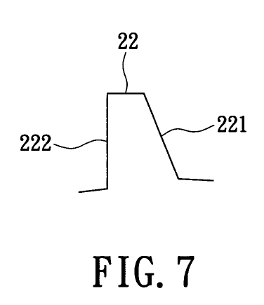

The stepped ratchet wheel 20 is mounted inside the inner hole 12, having an axially extended tool hole 21 (see FIG. 6) adapted to receive a torsional tool, and a series of teeth 22 radially arranged along the periphery at one end (see FIGS. 6 and 6A). The teeth 22 each have a first sidewall 221 and a second sidewall 222 respectively sloping at two sides at different angles for locking/unlocking control. Alternatively, the teeth 22 can be made having the respective first sidewall 221 to be a sloping wall for locking control and the respective second sidewall 222 to be a vertical wall for unlocking control (see FIG. 7). After engagement between the teeth 22 of the stepped ratchet wheel 20 and the teeth 13 of the socket body 10, the constant force socket can be driven to lock/unlock the workpiece, for example, a screw bolt or the like. When locked, the teeth 22 of the stepped ratchet wheel 20 and the teeth 13 of the socket body 10 trip out automatically.

The spring member 30 is a compression spring received inside the inner hole 12 and sleeved onto the stepped ratchet wheel 20, having one end stopped against the ratchet wheel 20 and the other end. The spring member 30 forces the stepped ratchet wheel 20 into engagement with the teeth 13 of the socket body 10, enabling the teeth 22 of the stepped ratchet wheel 20 and the teeth 13 of the socket body 10 to trip out automatically after the workpiece (screw bolt or nut) has been locked. The positioning of the spring member 30 is not limited to the aforesaid arrangement, i.e., the spring member 30 can be set in any of a variety of positions that achieve the same effect.

The screw member 40 is a hollow member stopped against the other end of the spring member 30, having an outer thread 41 extended around the periphery and threaded into the inner thread 14 of the socket body 10. By means of rotating the screw member 40 inwards or outwards in the inner hole 12, the spring force of the spring member 30 is relatively adjusted. Therefore, the screw member 40 has two functions, one to hold down the parts of the constant force socket, and the other to adjust the torsion. After adjustment of the screw member 40, the screw member 40 may be welded to the socket body 10, or locked to the socket body 10 by lock means (not shown). Alternatively, the screw member 40 can movably be threaded into the inner thread 14 inside the inner hole 12 of the socket body 10 without locking for convenient adjustment.

When assembled, the teeth 22 of the stepped ratchet wheel 20 are meshed with the teeth 13 of the socket body 10 for transmission of rotary driving force, and the spring member 30 is stopped between the screw member 40 and the ratchet wheel 20 to keep the ratchet wheel 20 in engagement with the teeth 13. When in use, the coupling hole 11 of the socket body 1 can be attached to any of a variety of screw bolts and nuts, and the tool hole 21 of the ratchet wheel 20 can receive a torsion tool for turning the constant force socket and the workpiece to which the coupling hole 11 of the socket body 1 is attached. The spring member 30 holds down the ratchet wheel 30 in engagement with the teeth 13 of the socket body 10, and gives a room for enabling the ratchet wheel 20 to trip out when the applied force surpassed the set torsion during working.

If the applied force surpassed the set torsional force when locking the workpiece (screw bolt or nut) with a torsion tool, the teeth 13 and 22 will automatically trip out along the first sidewalls 131 and 221, and then the teeth 22 will be forced into engagement with the teeth 13 again by the spring member 30 after the ratchet wheel 20 has been biased through an angle. Further, the engagement between second sidewalls 132 and 222 prevents trip-out of the ratchet wheel 20 from the socket body 10 when rotated in the reversed direction to loosen the workpiece (screw bolt or not).

As indicated above, if the applied force surpassed the set torsional force of the constant force socket when locking the workpiece (screw bolt or nut), the constant force trips out automatically to run idle, preventing damage to the constant force socket. When loosening the workpiece (screw bolt or not), the constant force socket is prohibited from tripping out, and can be driven to loosen the workpiece (screw bolt or nut) directly and positively.

It is not requisite to use the constant force socket with an electronic torsion tool (for example, an electronic wrench). Without an electronic torsion tool, the invention achieves torsion control. The constant force socket of the present invention is practical for use in any of a variety of industries including machinery industry, automobile industries, electronic equipment industry, food equipment industry, and etc., to lock or unlock screw bolts and nuts.

As indicated above, after installation of the screw member 40, the spring member 30 and the ratchet wheel 20 in the socket body 10, the acceptable torsional force of the socket is set. When locking the workpiece (screw bolt or nut), the maximum torsional force is transmitted through the constant force socket to the workpiece. When unlocking the workpiece, the ratchet wheel does not trip out, and the torsional force is positively transmitted to the workpiece, causing the workpiece to be accurately unlocked (loosened).

Although a particular embodiment of the invention has been described in detail for purposes of illustration, various modifications and enhancements may be made without departing from the spirit and scope of the invention. Accordingly, the invention is not to be limited except as by the appended claims.

1-8. (canceled)

9. A constant force socket comprising:
a coupling hole having an open end and a closed end;
an inner hole having an open end and a closed end;
wherein the closed end of the coupling hole abuts the closed end of the inner hole;
an interior threaded region located in said inner hole proximate said open end thereof;
a first set of teeth radially disposed in an interior of said inner hole proximate said closed end of said inner hole;
a ratchet wheel having a first end and a second end and having a region of relatively greater diameter terminating in said first end and a region of relatively smaller diameter terminating in said second end;
wherein the ratchet wheel is mounted in the inner hole;
a second set of teeth radially disposed around said first end of said ratchet wheel;
wherein said first set of teeth and said second set of teeth are adapted to engage one another;
a torsion tool hole at said second end of said ratchet wheel;
a spring mounted around said region of said ratchet wheel of relatively smaller diameter and abutting at a first end thereof said region of said ratchet wheel of relatively greater diameter; and
a pressure adjusting element having an exterior threaded region adapted to threadably engage said interior threaded region in said inner hole;
wherein a first side of said pressure adjusting element contacts a second end of said spring; and
wherein rotation of said pressure adjusting element within said inner hole adjusts an amount of pressed force on said spring and thus on said ratchet wheel.

10. The constant force socket of claim 9 wherein:
each tooth in said first set of teeth has an inclined side and a vertical side; and
each tooth in said second set of teeth has an inclined side and a vertical side.

11. The constant force socket of claim 9 wherein:
each tooth in said first set of teeth has a first inclined side and a second inclined side and wherein said first inclined side and said second inclined side slope at different angles from one another; and
each tooth in said second set of teeth has a first inclined side and a second inclined side and wherein said first inclined side and said second inclined side slope at different angles from one another.
